(19) United States
(12) Patent Application Publication
(10) Pub. No.: US 2013/0145438 A1
(43) Pub. Date: Jun. 6, 2013

(54) MOBILE EQUIPMENT AND SECURITY SETTING METHOD THEREOF

(71) Applicants: Jinwook Choi, Seoul (KR); Seungwon Lee, Seoul (KR); Seungcheon Baek, Seoul (KR); Jungsu Lee, Seoul (KR)

(72) Inventors: Jinwook Choi, Seoul (KR); Seungwon Lee, Seoul (KR); Seungcheon Baek, Seoul (KR); Jungsu Lee, Seoul (KR)

(73) Assignee: LG ELECTRONICS INC., Seoul (KR)

(21) Appl. No.: 13/816,169

(22) PCT Filed: Aug. 19, 2010
(86) PCT No.: PCT/KR2010/005477

§ 371 Date: Feb. 8, 2013

(51) Int. Cl. H04W 12/08

(52) U.S. Cl. CPC H04W 12/08
USPC 726/4

(57) ABSTRACT

The present invention relates to mobile equipment and a security setting method thereof for improving security of an object accessible by a user and for providing an easy security setting for the user by controlling user rights for the object according to a security setting pattern of the user. To this end, mobile equipment according to an embodiment of the present invention comprises: a mode management unit which determines a security setting mode; a setting management unit which checks a preset security setting in the case that the security setting mode is a first mode, and checks a security setting corresponding to time or location in a security setting pattern in the case that the security setting mode is a second mode; and a right control unit which controls user rights for an object according to the checked security setting, wherein the security setting pattern is changed on the basis of information on the time or location.

### TECHNICAL FIELD

The present invention relates to a mobile equipment and a method of setting security in the mobile equipment, and more particularly to a mobile equipment that controls a security setting of an accessible object and a method of setting security of an object in the mobile equipment.

### BACKGROUND ART

The provision of multiple and various functions by a recent mobile equipment requires a convenience consideration for a user interface (UI) such as a security setting.

### DISCLOSURE OF THE INVENTION

Therefore, an object of the present invention is to provide a mobile equipment that improves security of a user-accessible object and enables a user to conveniently utilize a security setting function, by controlling a user authority over an object according to a security setting pattern.

To achieve these and other advantages and in accordance with the purpose of the present invention, as embodied and broadly described herein, there is provided a mobile equipment which includes a mode management unit that determines a security setting mode, a setting management unit that confirms a pre-set security setting in a case where the security setting mode is a first mode, and confirms a security setting corresponding to time or location in a security setting pattern in a case where the security setting mode is a second mode, and an authority control unit that controls a user authority over an object according to the confirmed security setting, and in which the security setting pattern is changed based on time information or location information.

According to the embodiment, the user authority may include a plurality of levels. According to the embodiment, the plurality of the levels may be categorized by user's access to the object is permitted. According to the embodiment, the plurality of the levels may be categorized by a technique of displaying the object.

According to the embodiment, a type of the object may be a file or a folder. According to the embodiment, the file may be an executable file of an application or a data file. According to the embodiment, the data file may be a content file. According to the embodiment, the type of the object may be a shortcut or a group of the shortcuts. According to the embodiment, the group of the shortcuts may make up a page. According to the embodiment, the object may include a waiting screen.

According to the embodiment, the object may be displayed in such a manner that the object is different in size, shape, or color depending on the user authority. The mobile equipment may further include a display unit that displays the security setting mode.

The mobile equipment may further include an input unit that receives an input changing the security setting mode, and the mode management unit may change the security setting mode, based on the received input. The mobile equipment may further include an input unit that receives an input changing the security setting pattern, and the setting management unit may change the security setting pattern based on the received input.

The mobile equipment may further include an input unit that receives an input changing the user authority, and the authority control unit changes the user authority, based on the received input. According to the embodiment, the input may include at least one of a keypad, a touch pad, a sound sensor, an optical sensor, an acceleration sensor, and a gyro sensor.

To achieve these and other advantages and in accordance with the purpose of the present invention, as embodied and broadly described herein, there is provided a method of setting security in a mobile equipment, including determining a security setting mode, confirming a pre-set security setting in a case where the security setting mode is a first mode, confirming a security setting corresponding to time or location in a security setting pattern in a case where the security setting mode is a second mode; and controlling a user authority over an object according to the confirmed security setting. In the method, the security setting pattern is changed based on time information or location information.

To achieve these and other advantages and in accordance with the purpose of the present invention, as embodied and broadly described herein, there is provided a mobile equipment which includes a mode management unit that determines a security setting mode, a setting management unit that confirms a pre-set security setting in a case where the security setting mode is a first mode, and confirms a security setting corresponding to time or location in a security setting pattern in a case where the security setting mode is a second mode, and an authority control unit that cancels access limitation to all the objects on which the access limitation is imposed or sets all the access-limitation-cancelled objects to the access limitation, according to the confirmed security setting, and in which the security setting pattern is changed based on time information or location information.

### EFFECTS OF THE INVENTION

According to an embodiment of the present invention, the mobile equipment enables the user to use it more conveniently and safely by using a patterned security setting that is patterned for him/her and thereby providing a security environment corresponding to an environment where the mobile equipment is used. Particularly, the mobile equipment makes a precise security setting possible and automatically configures the security setting suitable for a given situation by using the security setting that is patterned on a basis of an object. As a result, there is an advantage that the user saves time and effort that would otherwise have been spent.

### BRIEF DESCRIPTION OF THE DRAWINGS

FIG. 1 is a conceptional view illustrating situation-based screens of a mobile equipment according to an embodiment of the present invention.

FIG. 2 is a block diagram of the mobile equipment according to the embodiment of the present invention.

FIG. 3 is a block diagram illustrating a security setting module illustrated in FIG. 2.

FIG. 4 is a view illustrating security setting pattern tables according to the embodiment of the present invention.

FIGS. 5A and 5B are diagrams illustrating security level tables according to the embodiment of the present invention.

FIG. 6 is a view illustrating a data structure relating to a security setting according to the embodiment of the present invention.

FIG. 7 is a flow chart illustrating a security setting process according to the embodiment of the present invention.

FIGS. 8A and 8B are diagrams for describing screens on which a security setting mode according to a first embodiment of the present invention is displayed.

FIGS. 9A to 9C are diagrams for describing multiple security levels to which to set an object according to a second embodiment of the present invention.

FIGS. 10A and 10B are diagrams for describing multiple object types according to a third embodiment of the present invention.

FIGS. 11A and 11B are diagrams for describing the multiple object types according to a fourth embodiment of the present invention.

FIGS. 12A to 12C are diagrams for describing a process of having access to a user object according to the embodiments of the present invention.

FIGS. 13A to 13C are diagrams for describing a process of changing a user authorization which is imposed on the object according to the embodiments of the present invention.

FIGS. 14A and 14B are diagrams for describing a change of a security setting pattern according to the embodiment of the present invention.

FIGS. 15A and 15B are diagrams illustrating a security setting process according to another embodiment of the present invention.

### MODES FOR CARRYING OUT THE PREFERRED EMBODIMENTS

A mobile equipment according to an embodiment of the present invention is described in detail below referring to the accompanying drawings. Terms ‘module’ and ‘unit’ used hereinafter to describe elements of the mobile equipment according to the embodiment of the present invention are exchangeably coined only for the purpose of writing the specification with ease, and do not have any difference in meaning and interpretation.

Situation-Based Screens of Mobile Equipment

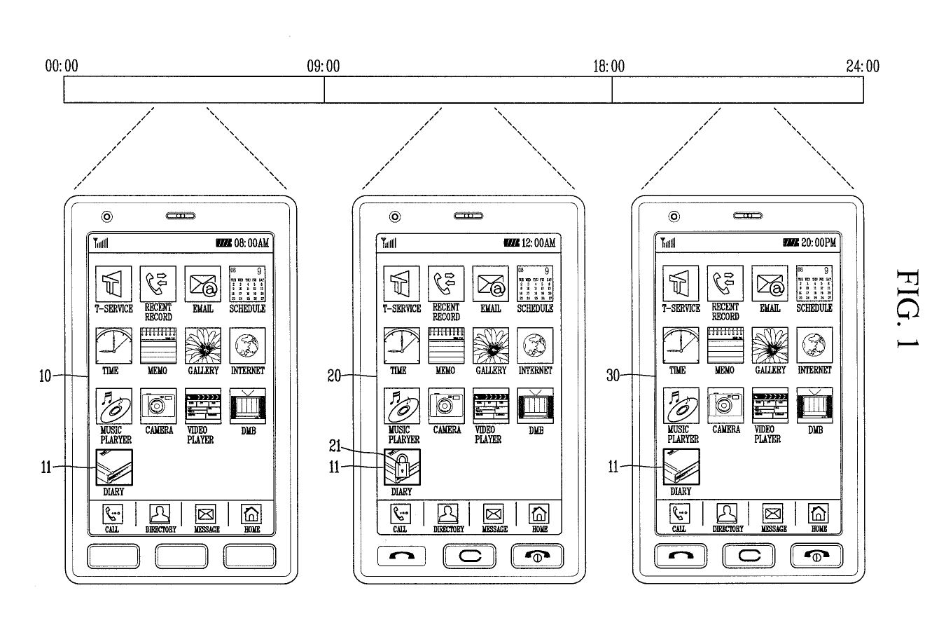

FIG. 1 is a conceptional view illustrating situation-based screens of the mobile equipment according to the embodiment of the present invention.

Multiple objects are displayed on screens 10, 20, and 30 of the mobile equipment according to the embodiment. The multiple objects are mapped onto functions provided by the mobile equipment, in one-to-one correspondence. When one is selected from the multiple objects, the mobile equipment, for example, calls a function corresponding to the selected object.

Furthermore, a user security setting pattern is stored in the mobile equipment according to the embodiment. The user security setting pattern, for example, means user authority that a user frequently imposes on the object at a specific time or a specific location. The mobile equipment controls the user authority over the object included in the user security setting pattern, at the specific time or at the specific location included in a security setting pattern.

For example, from FIG. 1, it is seen that changes in a screen over time occur, in a case where a first security setting corresponding to a time length from 18:00 o'clock to 9:00 o'clock (from 0:00 o'clock to 9:00 o'clock and 18:00 o'clock to 24:00 o'clock) and a second security setting corresponding to a time length from 9:00 o'clock to 18:00 o'clock are included in the user security setting pattern. As with the other objects, approach to an object 11 is possible at 8:00 or at 20:00 corresponding to the first security setting, and the object 11 is displayed on the screen 10 or 30 of the mobile phone in the same manner as the other objects. However, because unlike the other objects, user's approach to the object 11 is limited at 12:00 corresponding to the second security setting, the object 11 is displayed on the screen 20 of the mobile equipment in the manner different than the other objects. According to the embodiment, the object 11 is made different from another object by a lock-displayed item 21 of the object.

Mobile Equipment

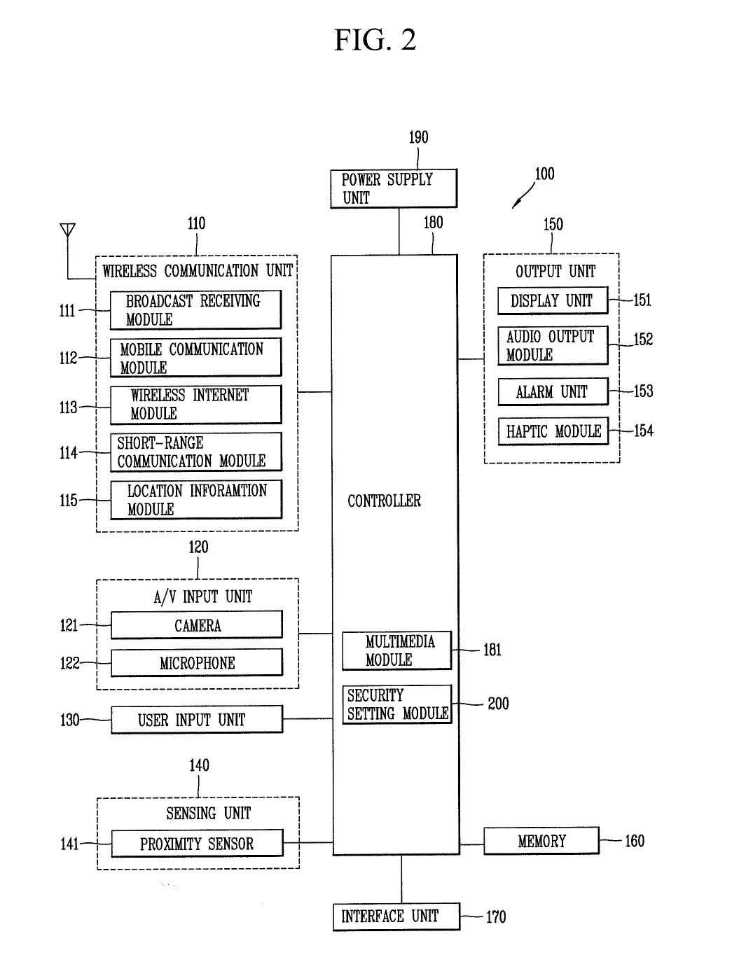

FIG. 2 is a block diagram of a mobile equipment according to an embodiment of the present invention.

The mobile equipment 100 includes a wireless communication unit 110, an A/V (Audio/Video) input unit 120, a user input unit 130, a sensing unit 140, an output unit 150, a memory 160, an interface unit 170, a controller 180, a power supply unit 190, etc. FIG. 1 shows the mobile equipment 100 having various components, but it is understood that implementing all of the illustrated components is not a requirement. The mobile equipment may be implemented by greater or fewer components. Hereinafter, each of the above components will be explained.

The wireless communication unit 110 typically includes one or more components allowing radio communication between the mobile equipment 100 and a wireless communication system or a network in which the mobile equipment is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast associated information may refer to information associated with a broadcast channel, a broadcast program or a broadcast service provider. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and/or receives radio signals to and/or from at least one of a base station, an external terminal and a server. Such radio signals may include a voice call signal, a video call signal or various types of data according to text and/or multimedia message transmission and/or reception.

The wireless Internet module 113 supports wireless Internet access for the mobile communication terminal. This module may be internally or externally coupled to the mobile equipment 100. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for acquiring a location (or position) of the mobile communication terminal. For example, the location information module 115 may include a GPS (Global Positioning System) module.

Referring to FIG. 2, the A/V input unit 120 is configured to receive an audio or video signal. The A/V input unit 120 may include a camera 121 and a microphone 122. The camera 121 processes image data of still pictures or video acquired by an image capture device in a video capturing mode or an image capturing mode. The processed image frames may be displayed on a display unit 151.

The image frames processed by the camera 121 may be stored in the memory 160 or transmitted via the wireless communication unit 110. Two or more cameras 121 may be provided according to the configuration of the mobile communication terminal.

The microphone 122 may receive sounds (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 may generate key input data from commands entered by a user to control various operations of the mobile communication terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like.

The sensing unit 140 detects a current status (or state) of the mobile equipment 100 such as an opened or closed state of the mobile equipment 100, a location of the mobile equipment 100, the presence or absence of a user's touch (contact) with the mobile equipment 100 (e.g., touch inputs), the orientation of the mobile equipment 100, an acceleration or deceleration movement and direction of the mobile equipment 100, etc., and generates commands or signals for controlling the operation of the mobile equipment 100. For example, when the mobile equipment 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor (not shown).

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, a haptic module 154, and the like.

The display unit 151 may display information processed in the mobile equipment 100. For example, when the mobile equipment 100 is in a phone call mode, the display unit 151 may display a User Interface (UI) or a Graphic User Interface (GUI) associated with a call. When the mobile equipment 100 is in a video call mode or a capturing mode, the display unit 151 may display a captured and/or received image or a GUI or a UI.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of these displays may be configured to be transparent so that outside may be seen therethrough, which may be referred to as a transparent display. A representative example of this transparent display may include a transparent organic light emitting diode (TOLED), etc. The rear surface portion of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile equipment 100. For instance, a plurality of displays may be arranged on one surface integrally or separately, or may be arranged on different surfaces.

Here, if the display unit 151 and a touch sensitive sensor (referred to as a touch sensor) have a layered structure therebetween, the structure may be referred to as a touch screen. The display unit 151 may be used as an input device rather than an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure.

When touch inputs are sensed by the touch sensors, corresponding signals are transmitted to a touch controller (not shown). The touch controller processes the received signals, and then transmits corresponding data to the controller 180. Accordingly, the controller 180 may sense which region of the display unit 151 has been touched.

Referring to FIG. 2, a proximity sensor (not shown) may be arranged at an inner region of the mobile equipment covered by the touch screen, or near the touch screen. The proximity sensor indicates a sensor to sense presence or absence of an object approaching to a surface to be sensed, or an object disposed near a surface to be sensed, by using an electromagnetic field or infrared rays without a mechanical contact.

The proximity sensor has a longer lifespan and a more enhanced utility than a contact sensor. The proximity sensor may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

In the following description, for the sake of brevity, recognition of the pointer positioned to be close to the touch screen without being contacted will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

The proximity sensor detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed in the mobile equipment 100. The audio output module 152 may include a receiver, a speaker, a buzzer, etc.

The alarm unit 153 outputs a signal for informing about an occurrence of an event of the mobile equipment 100. Events generated in the mobile equipment may include call signal reception, message reception, key signal inputs, and the like. In addition to video or audio signals, the alarm unit 153 may output signals in a different manner, for example, to inform about an occurrence of an event. For example, the alarm unit 153 may output a signal in the form of vibration. Such video signal or audio signal may be output through the display unit 151 or the audio output module 152. Accordingly, the display unit 151 or the audio output module 152 may be categorized into part of the alarm unit 153.

The haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile equipment 100.

The memory 160 may store software programs used for the processing and controlling operations performed by the controller 180, or may temporarily store data (e.g., a map data, phonebook, messages, still images, video, etc.) that are inputted or outputted. The memory 160 may store therein data on vibrations and sounds of various patterns output when a touch is input onto the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile equipment 100 may be operated in relation to a web storage device that performs the storage function of the memory 160 over the Internet.

The interface unit 170 serves as an interface with every external device connected with the mobile equipment 100. For example, the external devices may transmit data to an external device, receives and transmits power to each element of the mobile equipment 100, or transmits internal data of the mobile equipment 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like. Here, the identification module may be a chip that stores various information for authenticating the authority of using the mobile equipment 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the mobile equipment 100 via a port.

When the mobile equipment 100 is connected with an external cradle, the interface unit 170 may serve as a passage to allow power from the cradle to be supplied therethrough to the mobile equipment 100 or may serve as a passage to allow various command signals inputted by the user from the cradle to be transferred to the mobile equipment therethrough. Various command signals or power inputted from the cradle may operate as signals for recognizing that the mobile equipment is properly mounted on the cradle.

The controller 180 typically controls the general operations of the mobile equipment. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

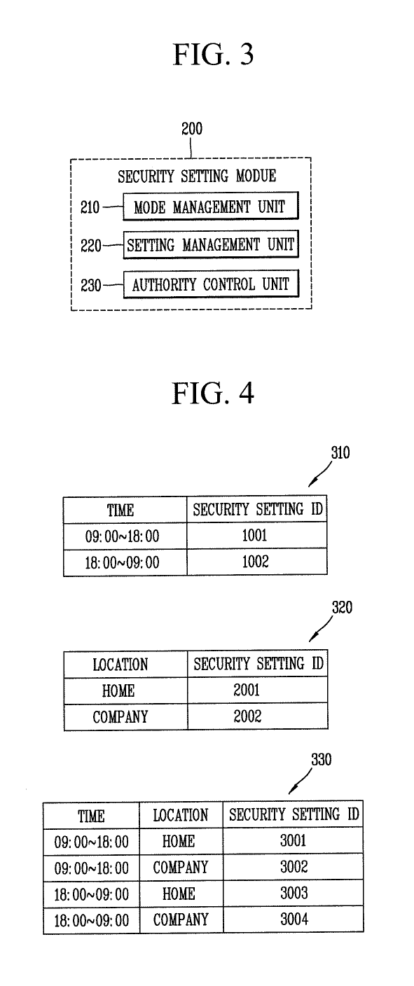

On the other hand, according to the embodiment, the controller 180 may further include a security setting module 200. The security setting module 200 is described in detail below referring to FIG. 3.

FIG. 3 is a block diagram illustrating the security setting module 200 illustrated in FIG. 2. The security setting module 200 according to the embodiment of the present invention includes a mode management unit 210, a setting management unit 220, and an authority control unit 230.

The mode management unit 210 determines a security setting mode. For example, the mode management unit 210 reads the security setting mode stored in the memory 160. The security setting module according to the embodiment includes a static security setting mode and a dynamic security setting mode. The static security setting mode is a mode in which the mobile equipment 100 applies a predetermined static security setting to the object regardless of the time and the location. In addition, the dynamic security setting mode is a mode in which in the security setting pattern the mobile equipment 100 applies the security setting, corresponding to the time in the mobile equipment 100 or to the location of the mobile equipment 100, to the object. At this point, a security setting pattern is changed, based on the time or the location at which a user generates changes and deletes the security setting with respect to the object.

The setting management unit 220 confirms a pre-set security setting in a case where the security setting mode is the static security setting mode, and confirms the security setting with respect to the object, corresponding to the time or the location, in the security setting pattern in a case where the security setting mode is the dynamic security setting mode.

For example, the setting management unit 220 confirms the security setting mode determined by the mode management unit 210. In a case where the security setting mode is the static security setting mode, the setting management unit 220 confirms the security setting that is stored in the memory 160 and is set in advance. In addition, in a case where the security setting mode is the dynamic security setting mode, the setting management unit 220 confirms the time in the mobile equipment 100 or the location of the mobile equipment 100 and confirms the security setting, corresponding to the time or the location, in the security setting pattern.

According to the embodiment, the setting management unit 220 confirms the time, based on a signal received from a repeater or using a built-in counter. In addition, the setting management unit 220 confirms the location of the mobile equipment 100 through the wireless communication unit 110 (for example, the location information module 115). In the setting pattern stored in the memory 160, the setting management unit 220 confirms the security setting corresponding to the confirmed time in the mobile equipment 100, or to the confirmed location of the mobile equipment 100.

The authority control unit 230 controls user authority over the object according to the confirmed security setting. For example, the authority control unit 230 changes the user authority over the object according to the security setting confirmed by the setting management unit 220. In addition, for example, the authority control unit 230 cancels an access limitation to all the objects on which the access limitation is imposed according to the security setting confirmed by the setting management unit 220, or sets all the access-limit-cancelled objects to the access limitation.

Tables and Data Structures

FIG. 4 is a view illustrating security setting pattern tables according to the embodiment of the present invention. Each security setting pattern table 310, 320, or 330 includes a security setting ID corresponding to each of the situations which are categorized by the time or the location.

The controller 180 according to the embodiment collects information on the time or the location at which the user imposes the user authority on the object, and forms the security setting pattern, based on the information on the time or the location, which is collected for a given period of time, and on the user authority that is imposed on the object. The security setting pattern includes the security setting corresponding to each time or each location, based on the time or location information.

For example, the security setting pattern table 310 includes an ID relating to the security setting of the object that the user frequently sets on a time basis in the mobile equipment 100. Accordingly, the security settings are made different from one another on the time basis. In addition, the security setting table 320 includes the ID relating to the security setting of the object that the user frequently provides on a location basis in the mobile equipment 100. Accordingly, the security settings are made different from one another on the location basis. In addition, the security setting table 330 includes the ID relating to the security setting of the object that the user frequently uses on time and location bases. Accordingly, the security settings are made different on the time and location bases.

The security setting pattern like this may be one that results from changing a pre-set template pattern according to the user's security setting pattern. In addition, the user may directly change the security setting pattern, and this change of the security setting pattern may be caused by the change of the information on the time or the location corresponding to each security setting included in the security setting pattern or by the change of the user authority over the object.

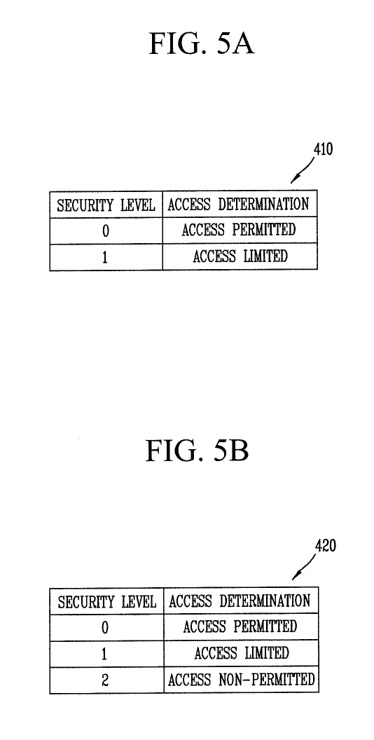

FIGS. 5A and 5B are diagrams illustrating security level tables according to the embodiment of the present invention. Each of the security level tables 410 and 420 in FIGS. 5A and 5B includes a security level ID field and an accessibility-determination field.

According to the embodiment, the user authority over the object may include multiple levels. The multiple levels may be categorized by whether the user's access to the object is permitted (accessibility). For example, the accessibility indicates whether the access to the object is permitted or limited. More specifically, the accessibility indicates whether executing, reading from, and writing to the object are permitted or limited. When the access to the object is permitted, the user may have access to the object without having to go through a separate authentication procedure. When the access to the object is limited, the user has to go through the authentication procedure to have access to the object.

In addition, according to the embodiment, the accessibility indicates whether the access to the object is permitted, limited, or non-permitted. More specifically, the accessibility indicates whether execution, reading from, and writing to the object are permitted, limited, or non-permitted. When the access to the object is permitted, the user may have access to the object without having to go through the separate authentication procedure. When the access to the object is limited, the user has to go through the authentication procedure, which is set on an object basis, to have access to the object. When the access to the object is non-permitted, the user has to go through the authentication procedure, which is set for all the objects, to have access to the object.

The security level ID field in each of the security level tables 410 and 420 in FIGS. 5A and 5B includes an identifier for distinguishing between security levels. For example, two or more IDs, each of which represents the security level, may be assigned according to the accessibility

The user may have access to the object corresponding to the security level 0 without having to go through the separate authentication procedure because the object is access-permitted that corresponds to the security level 0 in the security level table 410 in FIG. 5A. In addition, the user has to go through the separate authentication procedure to have access to the object corresponding to the security level 1 because the object is access-limited that corresponds to the security level 1 in the security level table 410

In addition, the user may have access to the object corresponding to the security level 0 without having to go through the separate authentication procedure because the object is access-permitted that corresponds to the security level 0 in the security level table 420 in FIG. 5B. In addition, the user has to go through the separate authentication procedure to have access to the object corresponding to the security level 1 because the object is access-limited that corresponds to the security level 1 in the security level table 420. In addition, the user has to go through the separate authentication procedure, which is set for all the objects, to have access to the object corresponding to the security level 2 because the access to the object is non-permitted that corresponds to the security level 2 in the security level table 420.

The security level tables 410 and 420 illustrated in FIG. 5 are described only as examples, and the security level tables having the different security levels may be present. The security level according to the embodiment may include the 8 levels (the levels corresponding to the presence of the authority to execute, read from and write to the object) according to the accessibility.

In addition, a technique of displaying each object may be determined in such a manner as to correspond to each of the security level tables 410 and 420. For example, the access-limited object is displayed on the screen in such a manner as to be distinguishable from the access-permitted object. In addition, for example, the object to which the access is set to be non-permitted is not displayed on the screen. In addition, for example, the objects are displayed in such a manner to be distinguishable among them according to the presence of the authority to execute, read from and write to the object.

FIG. 6 is a view illustrating a data structure relating to the security setting according to the embodiment of the present invention. The data structure 500 relating to the security setting includes fields for an object ID, an object type, an object name, and a user authority based on each security setting.

The object ID is an identifier for identifying the object. The object type is an identifier for distinguishing in type between the multiple objects when the multiple object types (a file, a folder and others) are present. The object name includes a string of letters that distinguishes in name between the objects. Each of the N user authority means the user authority over the object in each of the N security settings included in the security setting pattern table 310, 320, or 330 in FIG. 4. The user authority according to the embodiment includes the security level ID illustrated in FIG. 5.

Security Setting Function

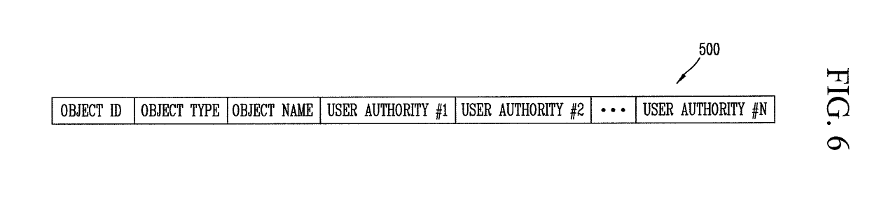

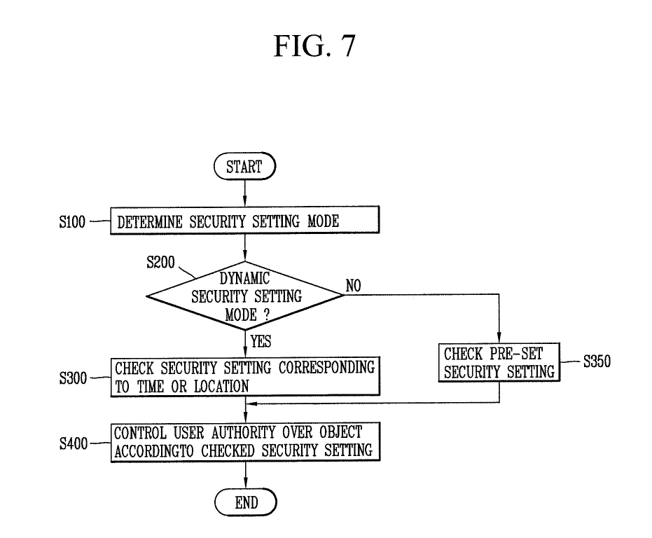

FIG. 7 is a flow chart illustrating a security setting process according to the embodiment of the present invention.

The mode management unit 210 determines the security setting mode (S100). For example, the mode management unit 210 reads the security setting mode stored in the memory 160. The security setting module according to the embodiment includes the static security setting mode and the dynamic security setting mode.

The setting management unit 220 determines whether the security setting mode is the dynamic security setting mode (S200), and confirms the security setting of the object corresponding to the time or the location in the security setting pattern in a case where the security setting mode is the dynamic security setting mode (S300). In Step S200, in a case where the security setting mode is not the dynamic security setting mode, that is, in a case where the security setting mode is the static security setting mode, the setting management unit 220 confirms the pre-set securing setting (S350).

The authority control unit 230 controls the user authority over the object according to the confirmed security setting (S400). For example, the authority control unit 230 changes the user authority over the object according to the security setting confirmed by the setting management unit 220. In addition, for example, the authority control unit 230 cancels the access limitation to all the objects on which the access limitation is imposed according to the security setting confirmed by the setting management unit 220, or sets all the access-limit-cancelled objects to the access limitation.

Security Setting Mode

FIGS. 8A and 8B are diagrams for describing screens on which the security setting mode according to a first embodiment of the present invention is displayed.

The display unit 151 displays the security setting mode. In addition, the user input unit 130 may receive an input that changes the security setting mode and the mode management unit 210 may change the security setting mode, based on the received input.

The security setting modes 612 and 622 are displayed on the screens 610 and 620 of the mobile equipment 100 according to the embodiment, respectively. In addition, when a toggle-type input, for example, is applied to the security setting mode 612, in a state where the security setting mode 612 is displayed on the screen 610, the security setting mode 622 is displayed on the screen 620 and the security setting mode is changed to the security setting mode 622. In addition, when the toggle-type input, for example, is applied to the security setting mode 622, in a state where the security setting mode 622 is displayed on the screen 620, the security setting mode 612 is displayed on the screen 610 and the security setting mode is changed to the security setting mode 612. The toggle-type input may include a touch or a drag.

Security Level

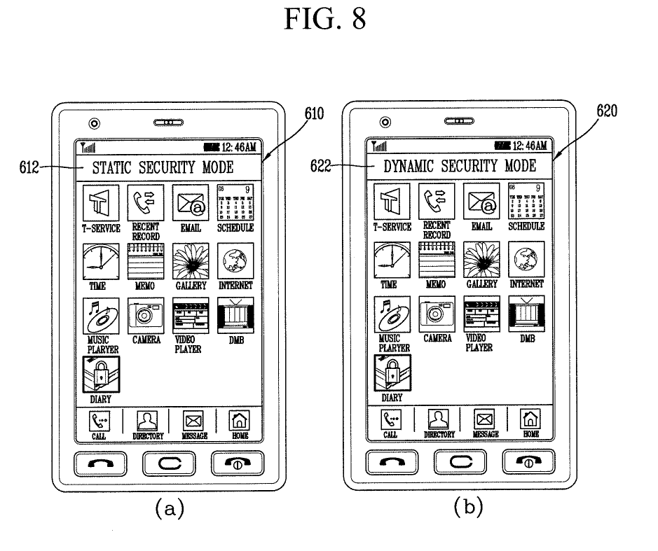

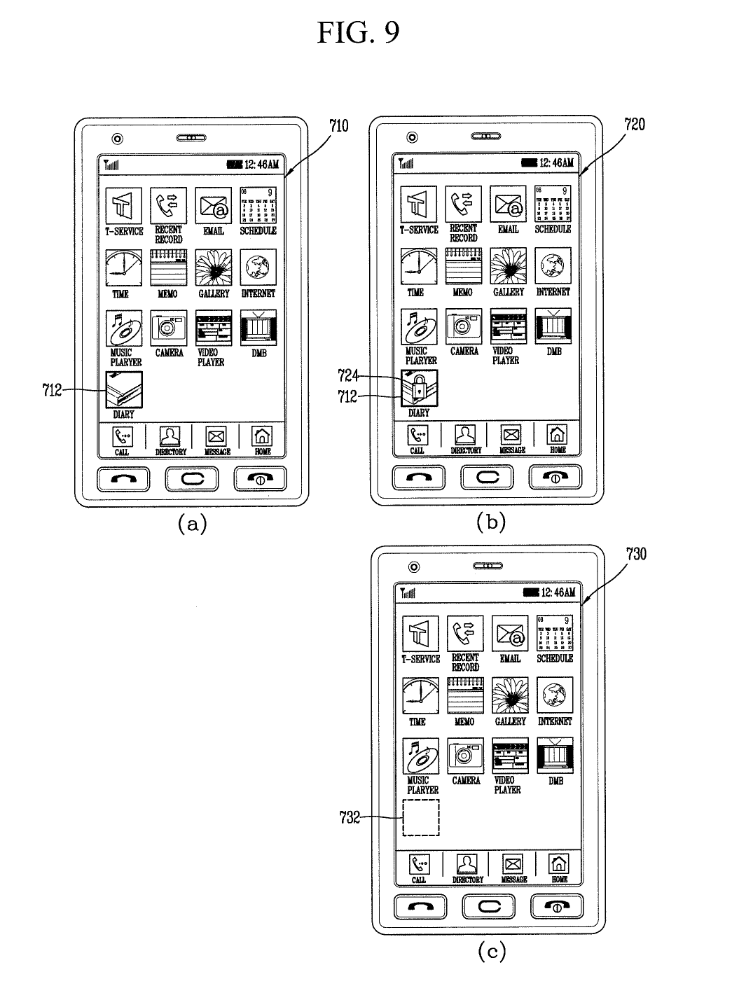

FIGS. 9A to 9C are diagrams for describing multiple security levels to which to set the object according to a second embodiment of the present invention.

The object may be displayed in such a manner that it is different in size, shape, or color depending on the user authority. FIGS. 9A to 9C are diagrams illustrating the screens on which the objects are displayed differently from each other depending on the user authority over the object.

FIG. 9A illustrates that the user authority, which is imposed on the object 712 displayed on the screen 710, represents access permission. In such a case, the object 712 is displayed on the screen 710 in the same shape as the different objects over which the user authority represents the access permission.

FIG. 9B illustrates that the user authority, which is imposed on the object 722 displayed on the screen 720, represents the access limitation. In such a case, the object 722 is displayed on the screen 720 in the different same shape than the different objects over which the user authority represents the access permission. For example, an item 724 that indicates the access limitation to the object may further be displayed on the object 722.

FIG. 9C illustrates that the user authority, which is imposed on the object 732 displayed on the screen 730, represents the non-access-permission. In such a case, the object 732 is not displayed on the screen 730. For example, the space that the object 732 took up remains as an empty space 732.

FIGS. 9A to 9C illustrate that object changes in shape depending on the user authority, but the object may change in size or color depending on the user authority. According to the embodiment, the object 722 in FIG. 9B may be displayed in a smaller size than the other objects. In addition, according to the embodiment, the object 722 in FIG. 9B may be displayed in black. In addition, a visual effect may be provided to the object 722 to distinguish it from the other objects, and for example, blurring treatment may be applied to the object 722.

Object Type

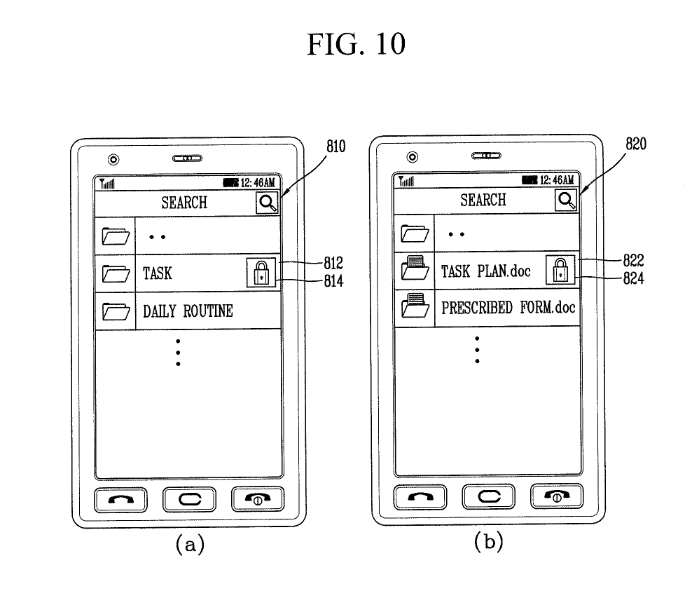

FIGS. 10A and 10B are diagrams for describing multiple object types according to a third embodiment of the present invention.

According to the embodiment, the object type may include a file, or a folder (a directory, a catalog, or a drawer). The file refers to a resource for storing an arbitrary information block or information. The folder refers to an imaginary container in which groups of files or the other folders are maintained and configured in a digital file system.

In addition, the file may include an executable file of an application and a data file. The executable file of the application refers to a file relating to execution of an application program, and the data file refers to a file in which to store data to be used by the application and a system, such as a text, an image, and a sound. In addition, the data file may include a content file. The content file refers to a file relating to information transmitted over the Internet, over the air interface, and via over-the-airwaves radio and television broadcasting, and information stored on a computer-readable medium such as a CD.

FIG. 10A illustrates the screen 812 on which the object 812 is the folder and the user authority is imposed on the object 812. According to the embodiment, the user authority, which is imposed on the object 812 may represent the access limitation, and an item 814 indicating the access limitation to the object 812 may further be displayed on the object 812. In such a case, the user's access to the folders and/or the files included in the object 812 is limited.

FIG. 10B illustrates the screen 820 on which the object 822 is the file and the user authority is imposed on the object 822. According to the embodiment, the user authority, which may be imposed on the object 822, represents the access limitation, and the item 824 indicating the access limitation to the object 822 may further be displayed on the object 822.

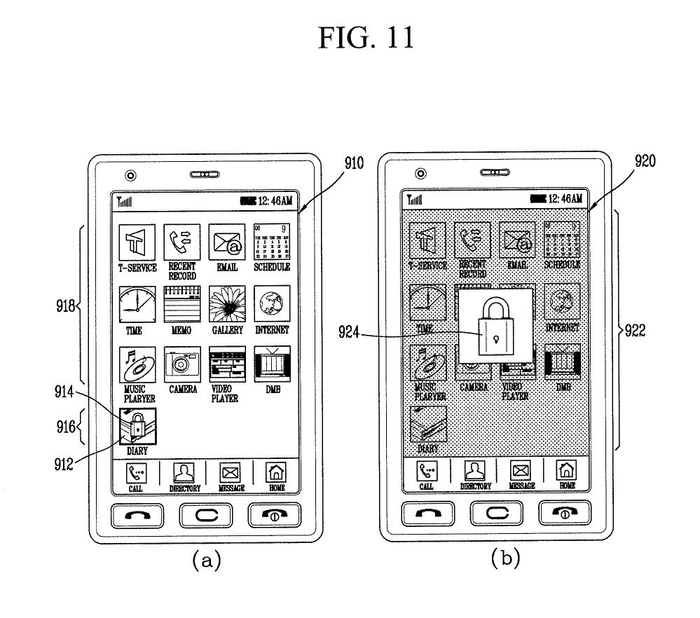

FIGS. 11A and 11B are diagrams for describing the multiple object types according to a fourth embodiment of the present invention.

According to the embodiment, the object may include a shortcut or a group of shortcuts. The shortcut refers to a small-sized file including the location of another file. In such a case, the shortcut is displayed in various formats, such as a grid, a wheel, or a page. In addition, the multiple shortcuts may make up the group, and the groups may make up the page. In addition, according to the embodiment, the object may include a waiting screen. At this point, the waiting screen refers to the screen displayed through the display unit 151 when the mobile equipment is in a waiting state (in an idle state or in a standby state).

FIG. 11A illustrates a screen 910 on which the object is the shortcut and the user authority is imposed on the object. According to the embodiment, the user authority, which is imposed on an object 912, may represent the access limitation, and an item 914 indicating the user authority over the object 912 may further be displayed on the object 912. Accordingly, an access-limited object 916 may be distinguished from objects 918 that are not access-limited.

FIG. 11B is a screen 920 on which the object is the group of shortcuts and the user authority is imposed on an object 922. According to the embodiment, the user authority, which is imposed on the object 922, may represent the access limitation, and an item 924 indicating the user authority over the object 922 may further be displayed on the object 922.

In addition, according to the embodiment, the groups of objects may make up the page. The page may refer to the groups of shortcuts that may be all displayed on one screen. Accordingly, when the multiple pages are present, the different security levels may be applied to the multiple pages, respectively.

In addition, according to the embodiment, the object may include the waiting screen. The mobile equipment 100 may set the waiting screen to the user authority. For example, the user authority, which is imposed on the waiting screen, refers to the access limitation, and the item indicating the user authority over the waiting screen may further be displayed on the waiting screen.

Function of Accessing Object

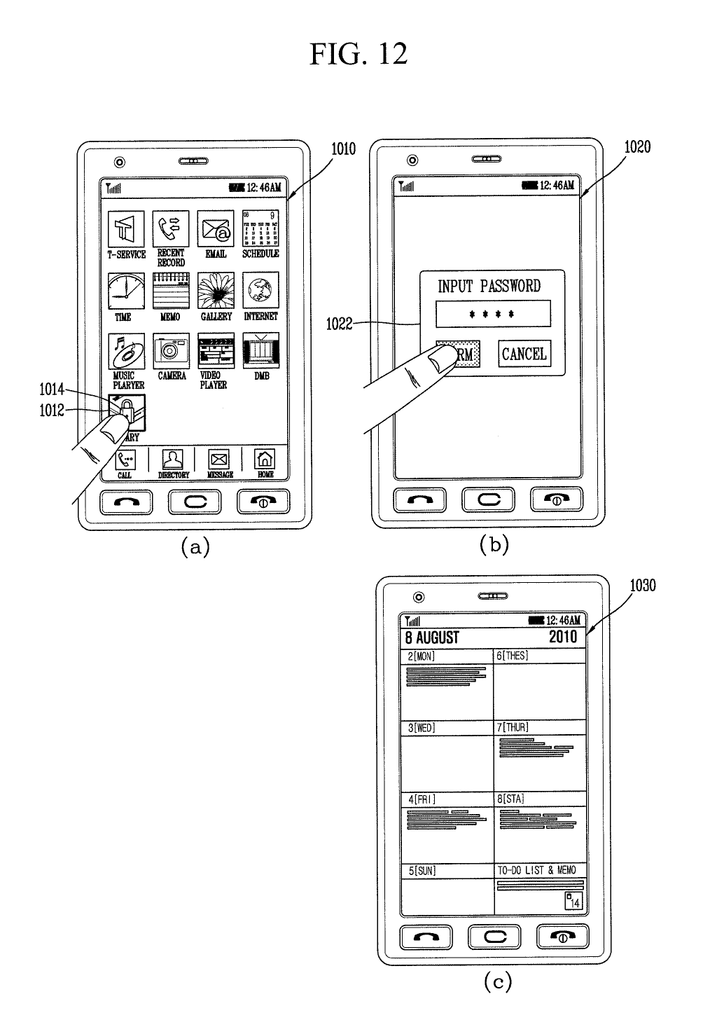

FIGS. 12A to 12C are diagrams for describing a process of having access to a user object according to the embodiments of the present invention.

According to the embodiment, the user may access the access-permitted object without having to go through the authentication procedure, but the user has to go through the authentication procedure to have access to the access-limited object. For example, an authentication key may be imposed on the object for the access limitation when setting the object to the access limitation. In such a case, the user has to input the pre-set authentication key to have access to the access-limited object. On the other hand, the authentication key, which is imposed on the object, may be the same as those imposed on the other objects, and the different authentication keys may be used with respect to all the objects, respectively.

The user input unit 130 receives the input to have access to the object, and the authority control unit 230 has access to the object, based on the input to have access to the received object. According to the embodiment, the user input unit 130 includes at least one of a keypad, a touch pad, a sound sensor, an optical sensor, an acceleration sensor, and a gyro sensor.

Referring to FIG. 12A, the user may select an object 1012 to have access to the access-limited object 1012. In such a case, an item 1014 may further be displayed which indicates the access limitation to the object 1012.

Referring to FIG. 12B, when the user selects the object in order to have access to the access-limited object 1012, an authentication window relating to the access to the object may be displayed. According to the embodiment, the user input unit 130 includes the keypad or the touch pad, and receives the input of a string of characters (including letters, numbers and symbols) as the authentication key. In addition, according to the embodiment, the user input unit 130 includes the sound sensor, and receives the input of the sound pattern through the sound sensor as the authentication key. According to the embodiment, the user input unit 130 includes the optical sensor and receives the input of an image of a face, an iris, or a fingerprint as the authentication key. The sound sensor may be the microphone 122, and the optical sensor may be the camera 121.

According to the embodiment, the user input unit 130 includes the acceleration sensor or the gyro sensor and receives the input of a movement or an inclination pattern of the mobile equipment 100 as the authentication key through the acceleration sensor or the gyro sensor. The authority control unit 230 compares the authentication key, which is imposed on the object 1012, with the input authentication key.

Referring to FIG. 12C, in a case where the input authentication key is matched to the pre-set authentication key, the controller 180 may have access to the object 1012. For example, in a case where the object 1012 is an object that calls a specific function provided by the mobile equipment 100, the controller 180 may call the function corresponding to the object 1012. According to the embodiment, an implementation screen 1030 on which to implement the function corresponding to the object 1012 is displayed through the display unit 151. In a case where the authentication key that is input to the access-limited object 1012, is not matched to the authentication key which is imposed on the object 1012, an error message may be displayed or the screen 1010 in FIG. 12A may be again displayed according to a modification example.

Function of Changing User Authorization

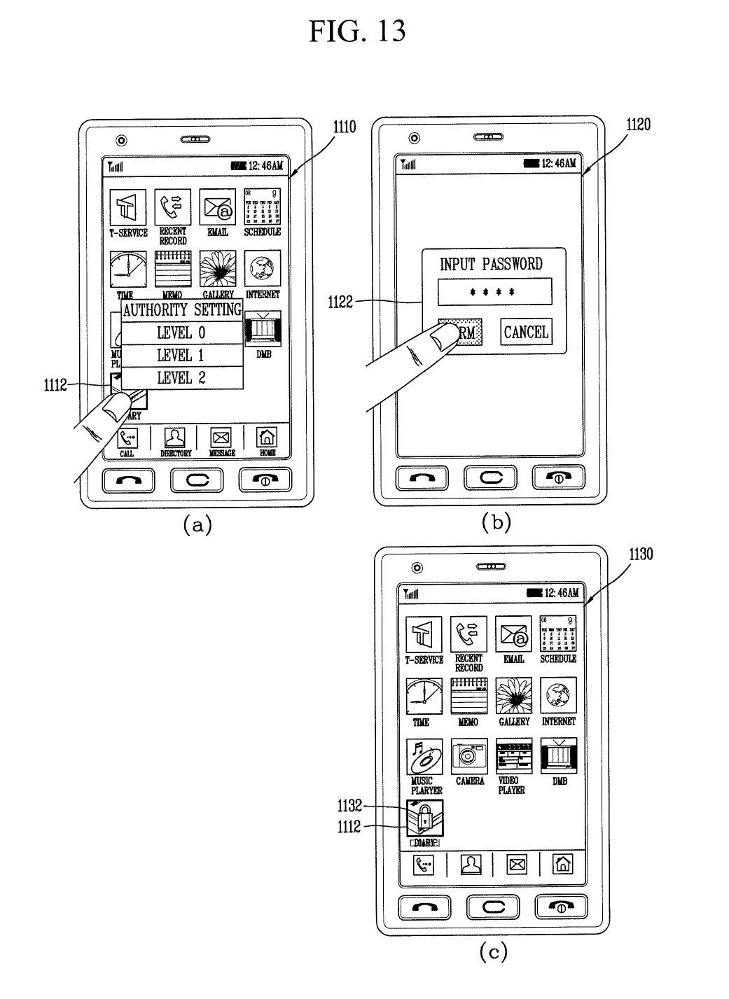

FIGS. 13A to 13C are diagrams for describing a process of changing the user authorization which is imposed on the object according to the embodiments of the present invention.

According to the embodiment, the user authority may be changed that is imposed on the object. The change of the user authority includes the authentication process illustrated in FIG. 12. The authenticated user has authority to change a setting of the user authority imposed on the object. Accordingly, the mobile equipment may provide a menu from which to change the user authority imposed on the object, to the authenticated user, and the user may change the user authority that is imposed on the object from the provided menu.

In addition, the security setting pattern may be changed depending on the change of the user authority over the object. The change of the user authority over the object in the dynamic security setting mode may result in the change of the security setting patterns based on the time or the location at which the user authority is changed and on the changed user authority. Accordingly, this change of the user authority over the object in the dynamic security setting mode has an influence on the security setting pattern as the user feedback.

Referring to FIG. 13A, when the authenticated user selects an object 1112 in accordance with the process in FIG. 12, the controller 180 displays the items from which to change the user authority over the object through the display unit 151. The items from which to change the user authority over the object include the menu from which to select the user authority over the object. In a case where the user authority over the object includes the multiple levels, the user may select any one from the multiple levels.

Referring to FIG. 13B, when the user authority over the selected object 1112 is selected as access-limited, a window for inputting the authentication key relating to the access limitation cancellation is displayed. The user inputs the authentication key and the input authentication key becomes an authentication key for having access to the object. According to the embodiment, the same authentication key may be used with respect to all the access-limited objects, and in such a case, the process in FIG. 13B may be omitted.

Referring to FIG. 13C, when the authentication key is input to the selected object 1112, the controller 180 changes the user authority that is imposed on the object 1112. In such a case, the changed user authority over the object 1112 may be access-limited, and an item 1132 may further be displayed that indicates the access limitation to the object 1112.

Function of Changing Security Setting Pattern

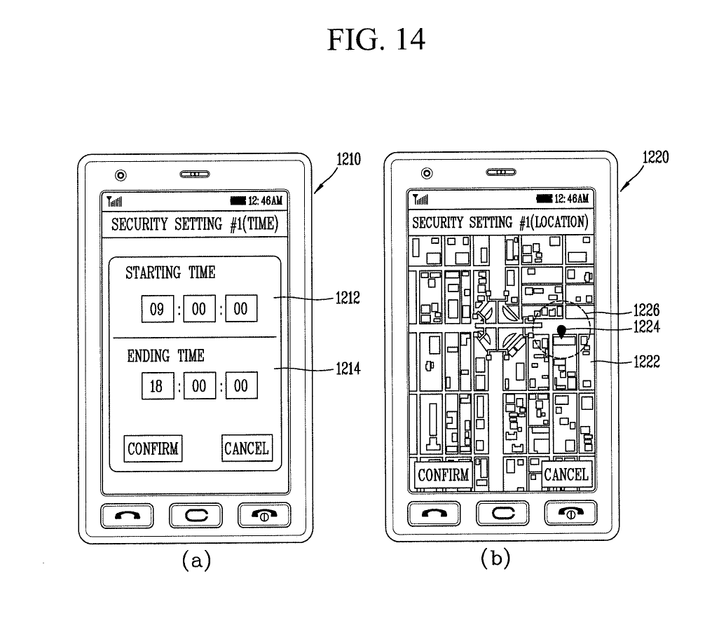

FIGS. 14A and 14B are diagrams for describing a change of the security setting pattern according to the embodiment of the present invention.

The security setting pattern is changed based on the time or the location at which the user authority is imposed on the object. In addition, the security setting pattern may be changed directly by the user, and the change of the security setting pattern may be made by adjusting each security setting included in the security setting pattern. According to the embodiment, the user may change directly the user authority over the object included in each security setting as illustrated in FIG. 13. In addition, the time (including starting time at which the corresponding security setting is applied and ending time), or the location (a range to which the corresponding security setting is applied) may be changed that corresponds to each security setting.

The user input unit 130 receives the input that changes the security setting pattern. The setting management unit 220 changes the security setting pattern based on the input received by the user input unit 130. According to the embodiment, the security setting pattern includes the security setting ID corresponding to each of the situations which are categorized by the time or the location. The controller 180 may change the time or the location that corresponds to each security setting included in the security setting pattern, according to the user's input.

Referring to FIG. 14A, when a menu item for changing the time information with respect to the security setting #1 is selected through the user input unit 130, the time information is displayed that corresponds to the security setting #1. The time information includes starting time 1212 and ending time 1214. When the input to change the starting time 1212 or the ending time 1214 is received through the user input unit 130, the controller 180 changes the time information corresponding to the security setting #1 according to the input starting time 1212 or the input ending time 1214.

Referring to FIG. 14B, when the menu item for changing the location information with respect to the security setting #1 is selected through the user input unit 130, the location information is displayed that corresponds to the security setting #1. The location information includes coordinates-information 1224 and a radius 1226. According to a modification example, the location information may be displayed along with map information 1222. When the input to change the coordinates-information 1224 or the radius 1226 is received through the user input unit 130, the controller 180 changes the location information corresponding to the security setting #1 according to the input coordinates-information 1224 or the input radius 1226.

According to the embodiment, when the coordinates-information 1224 is input through the user input unit 130, the radius 1226 is determined as a predetermined range. In addition, according to the embodiment, the coordinates-information 1224 and the radius 1226 may be input together through the user input unit 130. In addition, according to the embodiment, when address information is input through the user input unit 130, coordinates representing the input address information is input as the coordinates-information 1224 and the radius 1226 is determined as the predetermined range. At this point, in a case where the address information is on a building, the radius 1226 is determined as a range of the building. In addition, in a case where the address information is on an administrative district, the radius 1226 is determined as the range of the administrative district.

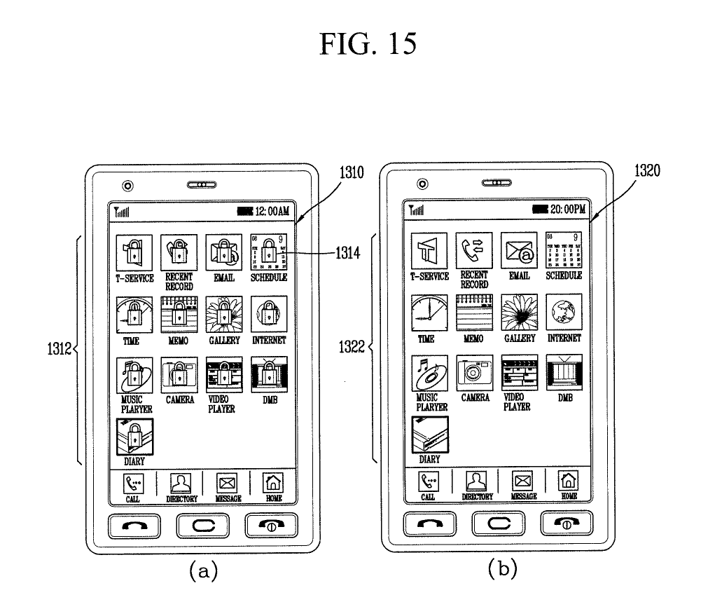

FIGS. 15A and 15B are diagrams illustrating a security setting process according to another embodiment of the present invention.

When the mobile equipment 100 is in the dynamic security setting mode, the authority control unit 230 cancels the access limitation to all the objects on which the access limitation is imposed, or sets all the access-limitation-cancelled objects to the access limitation, according to the time or the location.

Referring to FIG. 15A, in a case where the mobile equipment 100 is in the dynamic security setting mode, and is in a situation (for example, at 12:00 o'clock) corresponding to the first security setting included in the security setting pattern, the access limitation is imposed on objects 1312 displayed on a screen 1310 of the mobile equipment 100. In such a case, an item 1314 that indicates the access limitation to the object may further be displayed on each of the objects 1312.

Referring to FIG. 15B, in a case where the mobile equipment 100 is in the dynamic security setting mode, and is in a situation (for example, at 20:00 o'clock) corresponding to the second security setting included in the security setting pattern, the access limitation is cancelled that is imposed on objects 1322 displayed on a screen 1320 of the mobile equipment 100. In such a case, the items 1314 may be excluded that indicates the access limitation to the object displayed on each of the objects 1312.

On the other hand, referring back to FIG. 15A, in a case where the mobile equipment 100 is in the dynamic security setting mode, and is in a situation (for example, at 12:00 o'clock) corresponding to the first security setting included again in the security setting pattern, the once-canceled access limitation is imposed again on objects 1312 displayed on a screen 1310 of the mobile equipment 100. In such a case, the item 1314 that indicates the access limitation to the object may be displayed again on each of the objects 1312.

The mobile equipment described in the present disclosure includes not only a mobile phone, but also a smart phone, a notebook computer, a digital broadcasting terminal, a personal digital assistant (PDA), a portable multimedia player (PMP), a navigation apparatus, and a terminal that is capable of transmitting and receiving a text message. The configuration and the method of the embodiments according to the present invention are not applied in a limiting manner, but all of or some of the embodiments may be selectively combined with each other to create various modifications to the embodiments.

The terms or the words that are used in the present specification should not be interpreted in a manner that limits them to the common or dictionary definitions, but should be broadly interpreted to represent meanings and concepts that are consistent with the technological idea behind the present invention. Accordingly, the embodiments described in the present disclosure and the configurations illustrated serve only as preferable embodiments, not covering all the technological ideas behind the present invention and therefore it should be apparently understood that there may be various equivalents to and modifications to the embodiments and configurations at the time of filing the present patent application.

1.-17. (canceled)

18. A mobile equipment comprising:
a mode management unit that determines a security setting mode;
a setting management unit that confirms a pre-set security setting in a case where the security setting mode is a first mode, and confirms a security setting corresponding to time or location in a security setting pattern in a case where the security setting mode is a second mode; and
an authority control unit that controls a user authority over an object according to the confirmed security setting,
wherein the security setting pattern is changed based on time information or location information, and
wherein the user authority includes a plurality of levels.

19. The mobile equipment according to claim 18, wherein the plurality of levels are categorized by whether user's access to the object is permitted.

20. The mobile equipment according to claim 18, wherein the plurality of levels are categorized by a technique of displaying the object.

21. The mobile equipment according to claim 18, wherein a type of the object is a file or a folder.

22. The mobile equipment according to claim 21, wherein the file is an executable file of an application or a data file.

23. The mobile equipment according to claim 22, wherein the data file is a content file.

24. The mobile equipment according to claim 18, wherein the type of the object is a shortcut or a group of the shortcuts.

25. The mobile equipment according to claim 24, wherein the group of the shortcuts makes up a page.

26. The mobile equipment according to claim 18, wherein the object includes a waiting screen.

27. The mobile equipment according to claim 18, wherein the object is displayed in such a manner that the object is different in size, shape, or color depending on the user authority.

28. The mobile equipment according to claim 18, further comprising a display unit that displays the security setting mode.

29. The mobile equipment according to claim 18, further comprising an input unit that receives an input changing the security setting mode,
wherein the mode management unit changes the security setting mode, based on the received input.

30. The mobile equipment according to claim 18, further comprising an input unit that receives an input changing the security setting pattern,
wherein the setting management unit changes the security setting pattern, based on the received input.

31. The mobile equipment according to claim 18, further comprising an input unit that receives an input changing the user authority,
wherein the authority control unit changes the user authority, based on the received input.

32. The mobile equipment according to claim 31, wherein the input includes at least one of a keypad, a touch pad, a sound sensor, an optical sensor, an acceleration sensor, and a gyro sensor.

33. A method of setting security in a mobile equipment, comprising:
determining a security setting mode;
confirming a pre-set security setting in a case where the security setting mode is a first mode;
confirming a security setting corresponding to time or location in a security setting pattern in a case where the security setting mode is a second mode; and
controlling a user authority over an object according to the confirmed security setting,
wherein the security setting pattern is changed based on time information or location information, and
wherein the user authority includes a plurality of levels.

34. A mobile equipment comprising:
a mode management unit that determines a security setting mode;
a setting management unit that confirms a pre-set security setting in a case where the security setting mode is a first mode, and confirms a security setting corresponding to time or location in a security setting pattern in a case where the security setting mode is a second mode; and
an authority control unit that cancels access limitation to all the objects on which the access limitation is imposed or sets all the access-limitation-canceled objects to the access limitation, according to the confirmed security setting,
wherein the security setting pattern is changed based on time information or location information.
